(19) United States
(12) Patent Application Publication
(10) Pub. No.: US 2005/0110232 A1
(43) Pub. Date: May 26, 2005

(54) Hand truck with vertically movable platform

(76) Inventor: Joe DiBenedetto, Fullerton, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/964,579

(22) Filed: Oct. 12, 2004

Related U.S. Application Data
(60) Provisional application No. 60/510,951, filed on Oct. 10, 2003.

(51) Int. Cl. B62B 1/00

(52) U.S. Cl. 280/47.29

(57) ABSTRACT

A hand truck comprises a movable platform configured to lower a weight of a full beer keg to the ground from a height of a truck loading surface. The hand truck comprises a lowering mechanism comprising a controlled resistance device configured to lower the platform at a controlled rate. In one embodiment, the controlled resistance device comprises a plurality of springs and a pneumatic cylinder.

RELATED APPLICATIONS

This application claims the benefit of U.S. Provisional Patent Application Ser. No. 60/510,951, filed Oct. 10, 2003, the entire contents of which are incorporated herein by reference.

### BACKGROUND

1. Field of the Invention

The invention relates in general to the field of hand trucks for use in lowering or moving heavy items.

2. Description of the Related Art

When beer kegs are delivered to bars, restaurants and liquor stores, they often arrive on trucks, and need to be lowered down to ground level. In order to do this, the kegs are typically either lowered down by a particularly strong person, or the truck is provided with a loading ramp of one type or another. Unfortunately, it is not always possible to use a loading ramp due to cost or to the space available at a drop-off location. Additionally, lowering kegs manually can be strenuous and dangerous for the person doing the lowering. A full keg of beer typically weighs between about 130 and about 170 pounds, so it can be a challenging task to lower a keg from a height of a truck (typically as high as about 68″) without a ramp and without damaging the keg or injuring the person doing the lowering.

### SUMMARY

Thus, it is desirable to provide a relatively simple and inexpensive device which allows a person to lower a full beer keg (or other similarly weighted object) from a height of a truck loading surface down to a ground surface. Such a lowering device is preferably configured to lower the weight at a slow and/or controlled rate from the desired height.

According to one embodiment, a hand truck comprises a frame having a top portion, a bottom portion, and a longitudinal axis extending between the top portion and the bottom portion. The hand truck also comprises at least one handle mounted to the frame adjacent the upper portion, a pair of wheels attached to the frame adjacent the bottom portion, and a platform having a substantially planar upper surface that is oriented substantially perpendicular to the longitudinal axis of the frame. In this embodiment, the platform is configured to move axially along the longitudinal axis while maintaining the perpendicular orientation of the platform.

Additionally, the hand truck can be configured to lower a weight of between about 130 and about 170 pounds to a ground surface from a height of about 68″ at a controlled rate of descent. In one embodiment, the hand truck further comprises a resistance device configured to control a rate of descent of the platform. For example, in one embodiment, the resistance device is a pneumatic cylinder. The hand truck of this embodiment can further comprise one or more springs in mechanical communication with the platform to bias the platform toward a raised position. In some embodiments, the hand truck can further comprise at least one stabilizing leg extending forward from the frame.

According to another embodiment, a lowering device comprises at least one vertical frame member having a pair of wheels mounted to a bottom portion thereof, and at least one handle mounted to the at least one vertical frame member and extending rearwardly from the frame member. The device can further include a stabilizing leg mounted to the bottom portion of the frame member and extending forwardly to provide support for the device. In this embodiment, a generally planar platform is movably attached to the vertical frame member. The platform extends forwardly from the at least one frame member and is configured to move vertically along the vertical frame member. A resistance device is coupled to the platform and is configured to resist a gravitational force acting downwards on the platform. In further embodiments, the resistance device comprises a spring, a pneumatic cylinder, or other friction-increasing device. In still further embodiments, the resistance device can comprise a control configured to vary a resistance force of the resistance device.

In another embodiment, a method of lowering a weight from a height comprises placing a weight on a raised platform which is vertically movable on a hand-truck frame. The hand truck frame of this embodiment also comprises at least one wheel mounted to a lower portion thereof. The method further comprises opening a valve coupled to a pneumatic or hydraulic cylinder thereby lowering the weight on the platform to a ground level, then closing the valve and removing the weight from the platform. In some embodiments, the method further comprises controlling a rate of descent of the weight by varying a flow rate through the valve.

### BRIEF DESCRIPTION OF DRAWINGS

Having thus summarized the general nature of the invention, certain preferred embodiments and modifications thereof will become apparent to those skilled in the art from the detailed description herein having reference to the figures that follow, of which:

FIG. 1 is a perspective view of a hand truck with a movable platform shown in a “down” position.

FIG. 2 is a perspective view of a lower front section of the hand truck of FIG. 1.

FIG. 3 is a perspective view of a lower front section of the hand truck of FIG. 1 with the movable platform shown in a partially raised position.

FIG. 4 is a perspective view illustrating the hand truck of FIG. 3 from a different perspective.

FIG. 5 is a perspective view of a middle section of the hand truck of FIG. 4, showing a portion of a lowering mechanism.

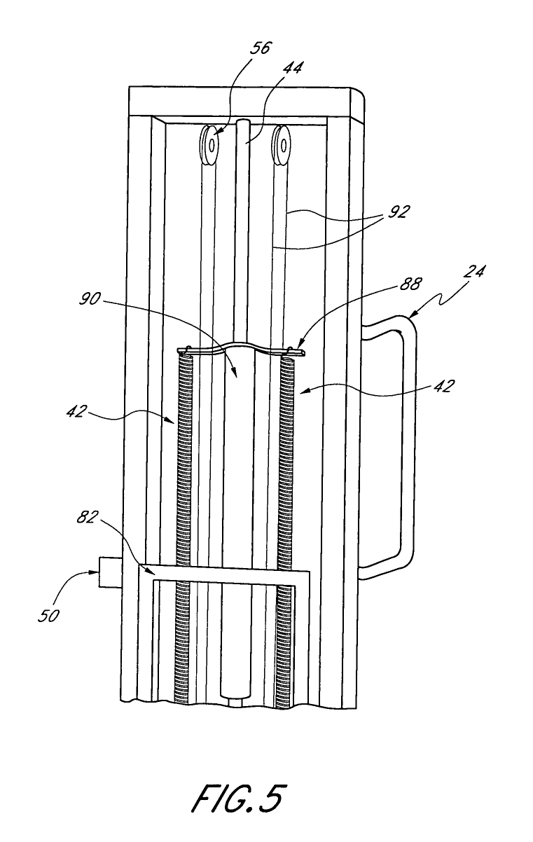

FIG. 6 is a perspective view of a lower rear section of the hand truck of FIG. 1.

FIG. 7 is a schematic illustration of one embodiment of a pulley arrangement for use in a lowering mechanism.

FIG. 8 is a schematic illustration of an alternative embodiment of a pulley arrangement for use in a lowering mechanism.

FIG. 9 is a schematic illustration of an alternative embodiment of a pulley arrangement for use in a lowering mechanism.

FIG. 10 is a schematic illustration of a pneumatic cylinder arrangement that can be used with one embodiment of the invention.

### DETAILED DESCRIPTION OF THE PREFERRED EMBODIMENTS

With reference to the attached figures, a hand truck with a lowering mechanism will now be described. The hand truck of the preferred embodiments, generally includes a movable platform that is configured to be biased in an upward direction, and which can be lowered to the ground at a controlled rate when an object of sufficient weight is placed on top of the platform.

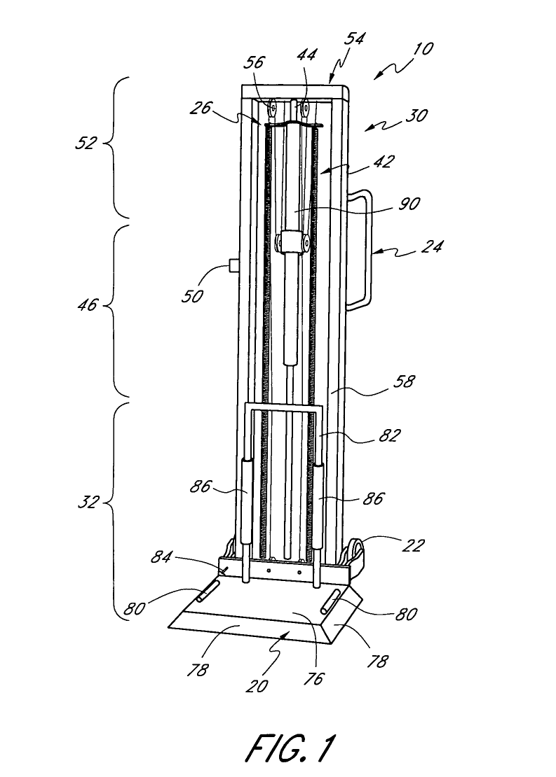

FIG. 1 illustrates one embodiment of a hand truck 10 comprising a platform 20, a pair of rear wheels 22, a pair of handles 24, and a lowering mechanism 26. In some embodiments, the hand truck 10 is configured to gently lower a weight of about 130 to about 170 pounds to the ground from a height of a truck loading bed or a storage container on a truck. In alternative embodiments, the hand truck can be configured to lower larger or smaller weights as desired. The height from which the weight is to be lowered can vary depending on the height of the particular truck used. Nonetheless, the hand truck 10 of the preferred embodiments can generally be configured to lower a weight from a height of up to about 70″, and in one preferred embodiment, the platform rises to an upper position at about 68″ above the ground. In some embodiments, as will be discussed in detail below, the hand truck 10 can be configured to stop the platform 20 at any desired height along its vertical path.

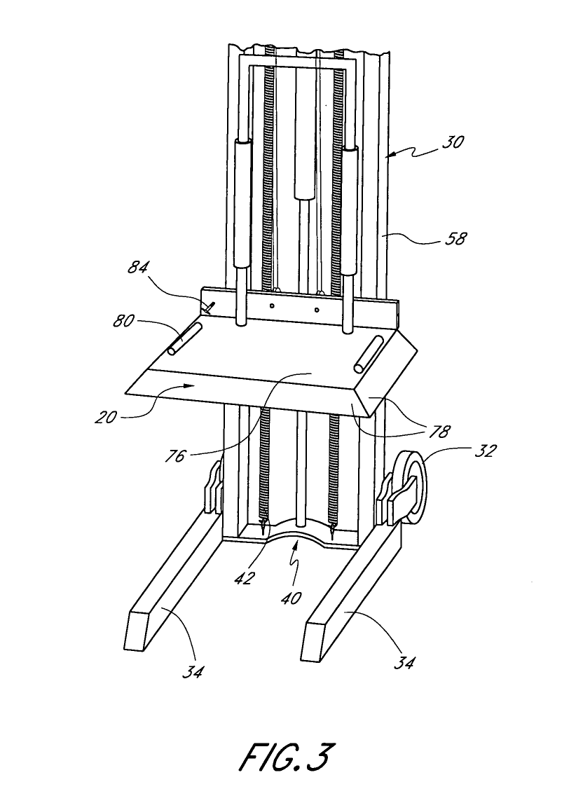

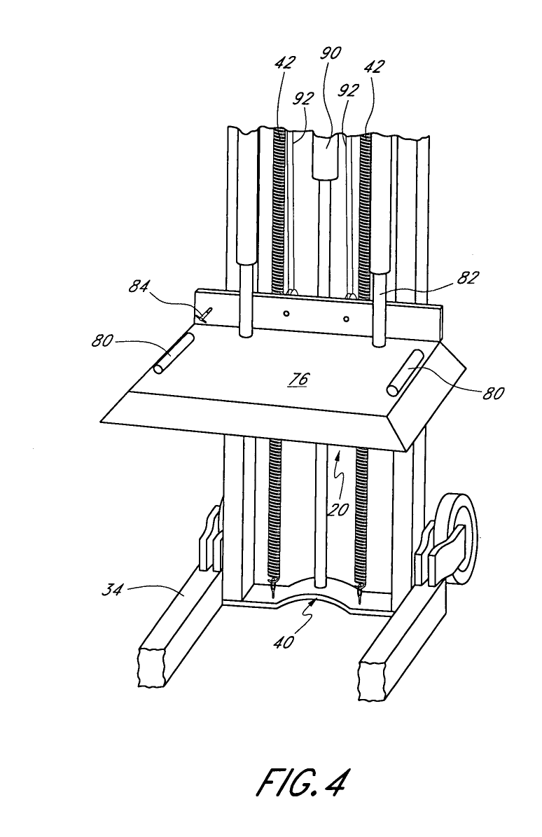

In the illustrated embodiment, the hand truck 10 has a frame 30 which generally comprises a lower portion 32 a pair of rear wheels 22 extending rearwardly from the frame, and a pair of stabilizing legs 34 (FIG. 3) extending forward from the frame 30. As shown, the frame 30 can further include a bottom plate 40 (FIG. 4) to which springs 42 and/or a central rod 44 can be attached. The vertical middle section 46 of the frame 30 can generally include the operator controls, such as handles 24 and a control 50. The upper section 52 of the frame generally includes an upper cross plate 54 to which the central rod 44 and any pulleys 56 can be attached.

In one embodiment, the platform 20 can be guided along its vertical path by tracks in the sides 58 of the frame 30. The platform 20 can include follower sections 60 configured to engage the vertically-extending side members 58 of the frame 30. In alternative embodiments, the platform 20 could be guided along a vertical path through contact with other vertically-extending members. For example, one or more guide rods could be provided to extend between the upper cross plate 54 and the lower cross plate 40, and the platform could comprise follower sections configured to engage the guide rods to guide the platform along a vertical path.

In one embodiment, as shown in FIG. 1, two handles 24 are rigidly attached to the middle section 46 of the frame 30 and extend rearward. The handles can comprise any suitable material, and can be attached to the frame in any suitable manner. For example, in the illustrated embodiment, the handles comprise sections of steel tubing welded to the frame 30. Although the illustrated embodiments show the hand truck with two handles, the skilled artisan will recognize that fewer or more handles could alternatively be provided.

The rear wheels 22 mounted to the lower section 32 of the frame 30 can generally be any size or type recognized as suitable. In the illustrated embodiment, the rear wheels 22 are shown spaced rearwardly from the frame 30 so as to provide additional stability, thereby preventing the hand truck from tipping backwards too easily.

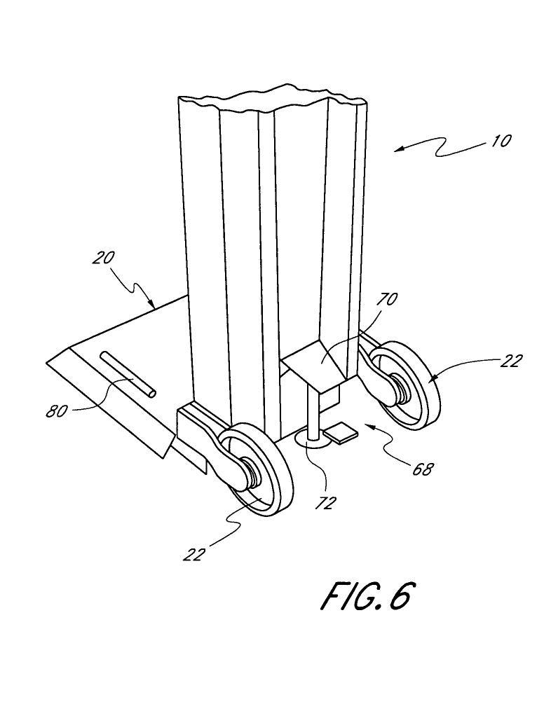

As shown in FIG. 6, the hand truck 10 can include a brake 68 configured to stop the hand truck from rolling forwards or backwards. In the illustrated embodiment, the brake 68 comprises a foot pedal 70 configured to press a pedestal 72 downward against a ground surface. In an alternative embodiment, one or more brakes can be provided to prevent rotation of one or both of the rear wheels 22. For example, such a brake could include clamps, calipers, or other devices configured to grip the wheels 22, or press against the wheels in a manner that prevents the wheels from rotating.

As shown in FIG. 3, the hand truck 10 can include stabilization legs 34 extending forwardly from the frame 30. The legs 34 preferably extend substantially the same distance from the frame 30 as the top surface 76 of the platform 20. This allows an object supported on the forwardmost edge of the platform 20 to be supported by a portion of the leg 34 in contact with the ground vertically below the edge of the platform 20. The skilled artisan will recognize that shorter legs could alternatively be used, but using a leg that is similar in length to the platform will provide a more stable support. In one embodiment, wheels 22 can be provided under the stabilization legs 34, in order to allow the hand truck to be easily movable while in a vertical orientation.

In one embodiment, the platform 20 is about 19″ wide by about 19″ deep, and is made of a sufficiently rigid material that it can support the weight of a desired load in a cantilevered manner. As shown, the platform 20 is supported by brackets extending rearward from the rear edge of the platform 20 and engaging the sides 58 of the hand truck frame 30. The platform 20 can also comprise a textured, knurled, patterned, or roughened surface to increase friction between the platform surface and the keg or other load placed thereon.

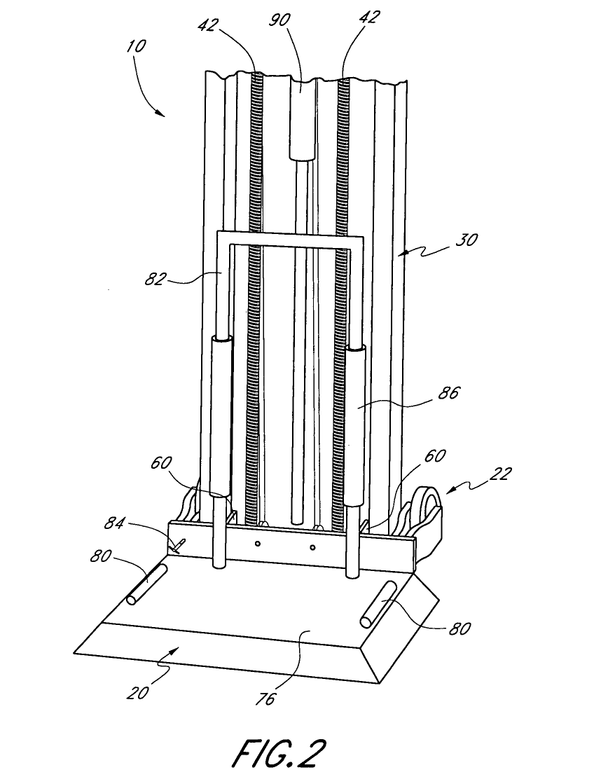

As shown in FIGS. 1-4, the platform 20 can include downward sloping edge surfaces 78 to facilitate loading of a keg or other weight onto the platform 20. As shown, the platform 20 can also include side guards 80 to prevent an object placed on the platform 20 from sliding sideways off of the platform 20. In the illustrated embodiment, the guards 80 comprise rigid tubular sections rigidly attached to the upper surface 76 of the platform 20. Additionally, a rear support bar 82 can be provided to prevent the keg (or other object) from interfering with the lowering mechanism components. In some embodiments, a keg or other weight can be strapped to the support bar 82 during lowering and/or maneuvering the hand truck. If desired, the support bar 82 can also be provided with bumpers 86 to contact a surface of a keg. In an alternative embodiment, the lifting mechanism can be enclosed by a solid plate, a series of bars, or by a screen to prevent objects from interfering with the lifting mechanism, and to protect users from being injured by the mechanism.

In one embodiment, as shown in FIGS. 1-4 for example, the platform 20 can include a manual lock 84 to lock the platform in the “down” position. The manual lock 84 can comprise a pin that can be slid rearward to engage a hole in a portion of the frame 30. In alternative embodiments, other manual locks, such as clamps, latches, clips, etc can also be used to maintain the platform in a “down” position. In alternative embodiments, one or more manual locks can be provided to secure the platform in a position other than the “down” position, such as an “up” position, or any other position in between.

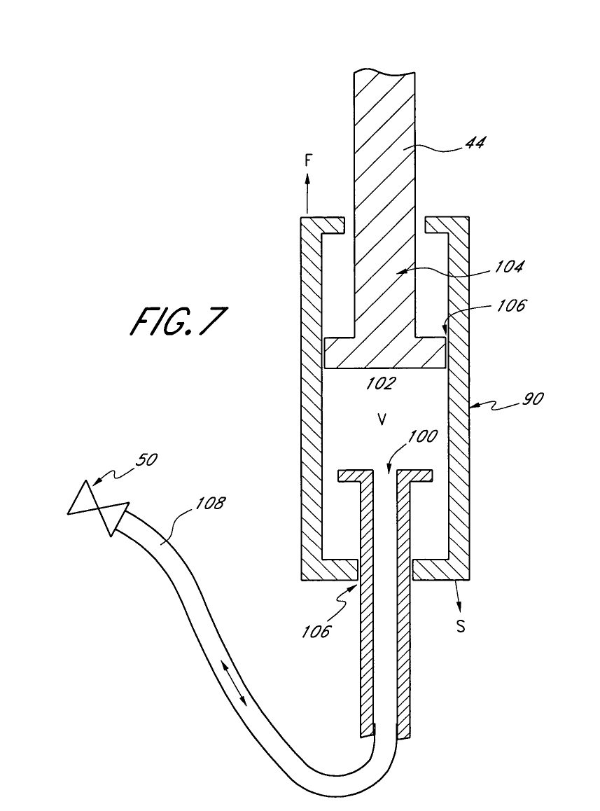

In the illustrated embodiment, the lowering mechanism generally comprises a pair of springs 42 with a first end mounted to the bottom plate 40, and a second end mounted to flanges 88 at an upper end of a movable cylinder 90 that is configured to be movable along the central rod 44. As will be clear to the skilled artisan in view of the present disclosure, the central rod 44 is not necessarily a single, solid rod. The central rod 44 can comprise, for example, the structure illustrated schematically in FIG. 7, or any of a variety of other structures in order to create a controlled resistance to movement along the axis of the central rod 44.

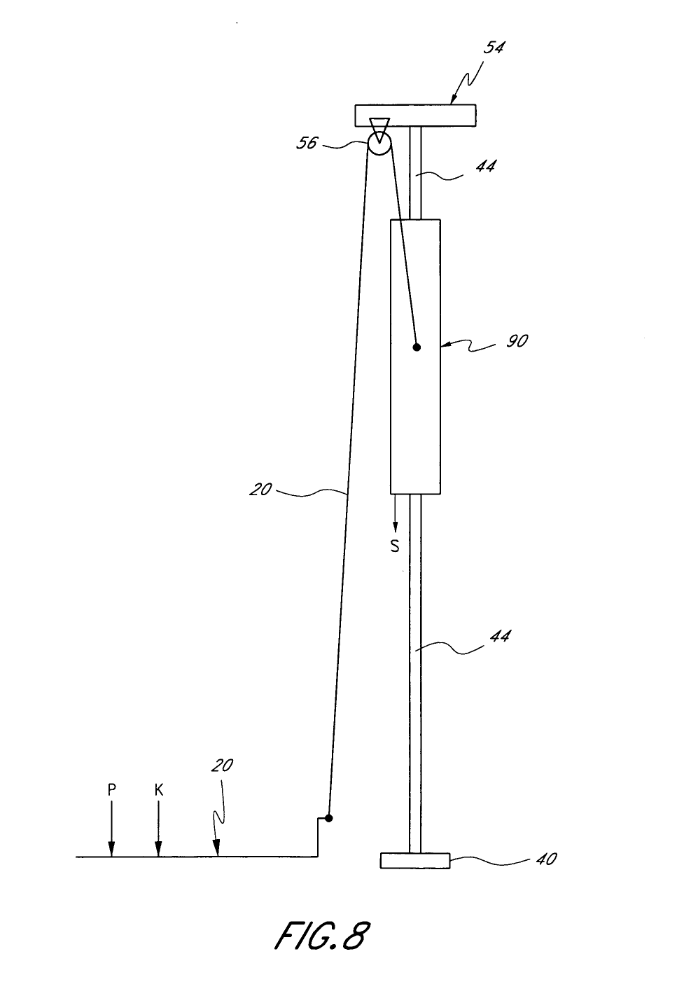

The springs 42 are generally configured to resist the lowering motion of the weighted platform 20, and to return the empty platform 20 to its raised position. In the illustrated embodiment, the cylinder 90 is a pneumatic cylinder configured to provide controlled resistance to both the lowering motion and the raising motion. The cylinder is generally configured to allow the platform 20 to be raised and lowered at a controlled rate by opening and closing a flow control valve 50 as will be further described below. The platform 20 is operatively joined to the movable cylinder 90 by a pair of cables 92 passing through a series of pulleys 56 (e.g. see FIGS. 8-10).

As shown, the cylinder 90 can comprise a pneumatic cylinder having a piston configured to force air through a confined outlet. As schematically shown in FIG. 7, the outlet 100 of the cylinder 90 can be joined in fluid communication with a flow control valve 50 which can be opened or closed to adjust a flow rate of air entering and/or leaving the cavity 102 of the cylinder 90. Any number of suitable piston/cylinder arrangements can be used to provide controlled resistance to the movement of the various system components of the hand truck 10. In an alternative embodiment, a hydraulic cylinder could also be used, and a flow control valve could be configured to control a flow rate of a hydraulic fluid between the cylinder and a fluid reservoir. In still another alternative embodiment, the piston could be omitted and/or replaced by any other friction-increasing device. For example, other friction increasing devices can include a brake comprising pneumatic, hydraulic or spring-biased calipers engaging a braking surface such as a rod, flange or other structure. Alternatively, such friction increasing devices can include a rotational clutch or other rotational friction-increasing device.

FIG. 7 schematically illustrates a piston 104 and cylinder 90 arrangement including the two forces that will cause the movable cylinder to move up or down. In the illustrated embodiment, if the spring force ‘S’ is greater than the force of the platform (e.g. when the platform is empty), the cylinder 90 will be biased toward moving downwards. As illustrated, downward movement of the cylinder 90 will cause the volume ‘V’ within the cylinder to increase. Since the seals 106 prevent air from entering the cylinder by any path other than through the outlet 100, the air pressure within the cylinder will decrease until the pressure applied by the vacuum within the cylinder is great enough to resist the downward spring force. Thus, in this situation, in order to allow the cylinder to move, the valve 50 must be open in order to allow air to flow into the cylinder. Similarly, upward motion of the cylinder (e.g. caused by a platform force ‘F’ greater than a spring force ‘S’) can be arrested by decreasing the volume ‘V,’ thereby increasing the pressure in the cylinder 90. In this situation, opening the valve 50 will allow air to flow out of the cylinder, and the cylinder to move upwards. The skilled artisan will recognize that these actions can be reversed simply by rearranging the piston 104 and the cylinder 90.

The valve 50 can be any suitable type of valve, such as a gate valve, a ball valve, a butterfly valve, a globe valve, etc. In one preferred embodiment, the valve is selected to provide control over the rate of airflow therethrough. The valve 50 can be actuated by turning, pressing, pulling or any other suitable motion. In the illustrated embodiment, a flow control valve with a rotatable actuator is provided. The valve is joined in fluid communication with the cylinder by a hose 108 (schematically shown in FIG. 7) or other suitable fluid-carrying structure.

In one embodiment, a system of cables 92 and pulleys 56 is provided in order to multiply the travel distance of the cylinder 90 sufficiently to achieve the desired platform 20 travel distance. For example, in the arrangement shown in the schematic side view of FIG. 8, the platform 20 is joined to the movable cylinder 90 by a cable 92 passing over a single pulley 56 attached to the upper plate 54 of the hand truck frame. As the spring force ‘S’ pulls the cylinder 90 down along the central rod 44, the platform 20 will be pulled upwards by a force equal to the spring force ‘S,’ and the platform 20 will travel a distance equal to the distance traveled by the cylinder 90.

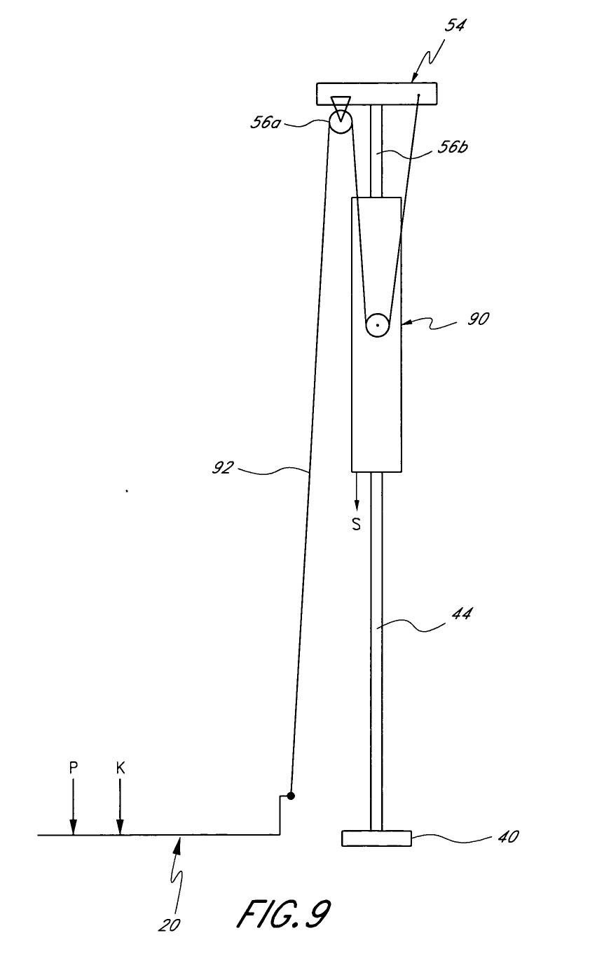

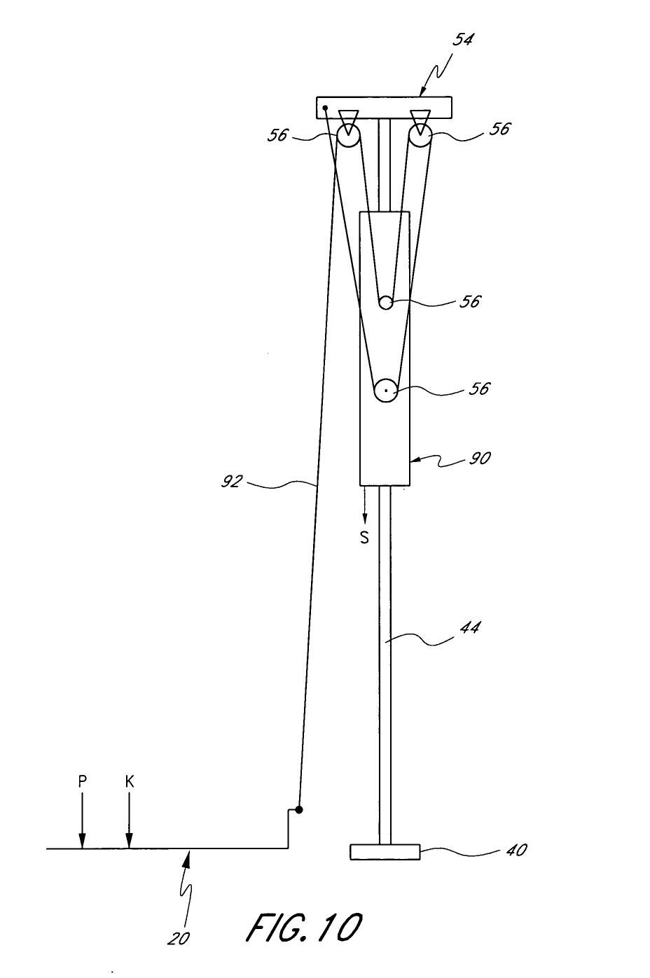

If a greater platform travel distance is desired, a pulley arrangement such as that schematically illustrated in FIG. 9 could be provided. FIG. 9 shows a system in which a cable 92 extends from the platform 20 to a first pulley 56a attached to the top plate 54 of the frame, the cable continues to a second pulley 56b attached to the movable cylinder 90, and the cable 92 is attached to the top plate 54. In this arrangement, the platform 20 will be pulled upwards by a force equal to half of the spring force ‘S’ and the platform 20 will travel twice the distance traveled by the cylinder 90. The system of FIG. 10 can be used to again double the platform travel distance, causing the platform 20 to travel four times the distance traveled by the cylinder 90, while applying an upward force on the platform 20 equal to ¼ the total spring force ‘S’. The illustrations of FIGS. 8-10 are merely schematic representations of certain exemplary embodiments. In alternative embodiments, the combinations of travel distance and mechanical advantage of the above pulley arrangements can be achieved by re-locating one or more of the pulleys as desired. For example, one or more pulleys can be located on the platform itself, or at other points on the frame or the cylinder as desired.

The springs 42 are preferably selected to apply sufficient force to raise the empty platform 20 to the highest desired position. The exact length and spring constant of the springs 42 will typically depend on other system components, such as the desired length of travel, the amount of mechanical advantage between the platform and the movable cylinder, friction, the weight of the platform, etc. For example, in the system of FIG. 8, the springs 42 will be selected to apply a force ‘S’ that is less than the weight ‘K’ of a keg, and greater than the weight ‘P’ of the empty platform. In the embodiment of FIG. 9, the springs 42 will be selected to apply a force ‘S’ that is less than twice the weight ‘K’ of a keg, and greater than twice the weight ‘P’ of the empty platform. In the embodiment of FIG. 10, the springs 42 will be selected to apply a force ‘S’ that is less than four times the weight ‘K’ of a keg, and greater than four times the weight ‘P’ of the empty platform.

The skilled artisan will recognize that the force applied by most springs depends on the amount of deflection of the spring multiplied by a spring constant, thus the spring force ‘S’ will be understood to refer to a range of forces depending on the amount of spring deflection and the position of the system components. Any number of springs of any of a variety of types can be used as desired. For example, in some embodiments, the system could be configured to incorporate one or more torsional springs. Alternatively still, counterweights could be used in place of a spring to provide the potential energy to return the empty platform 20 to its upper position. It is generally desirable to prevent the platform from quickly springing upwards and potentially causing injury to an operator or a bystander once a load is removed. In one embodiment, this problem can be avoided by biasing the valve 50 towards a closed position such that the valve can only be held open manually and will close once an operator removes his/her hand from the valve. In alternative embodiments, the spring force biasing the platform towards an up position can simply be selected to be substantially small so that the platform can only move upwards very slowly. In alternative embodiments, a hand truck may be provided with a manually-operable mechanism for returning the platform to the upper position. For example, such manually-operable mechanisms can include a hand crank driving a winch, a worm screw, a chain drive, or any other suitable mechanism.

In operation, when the platform is in its raised position and a weight is placed on the platform 20, the platform 20 can be gently lowered to the ground by opening the valve 50, and allowing air to flow through the valve. The rate at which the platform 20 is lowered can be varied by increasing or decreasing the resistance of the cylinder, such as by increasing or decreasing the flow rate of air through the valve 50. Once the platform 20 is lowered completely to the ground, the valve 50 can be closed, and the keg can be removed from the platform 20. The pressure within the cylinder 90 will preferably cause the platform 20 to remain in the lowered position until the valve 50 is opened.

With the platform 20 in the lowered position, the valve 50 can be opened, thereby allowing the unloaded platform 20 to rise to its upper position. Again, the rate at which the platform 20 moves upwards can be controlled by varying the flow rate of air through the valve 50. It is preferable that the platform 20 not be raised or lowered too quickly so as to avoid injury to people or objects that might be in the path of the platform 20.

With the platform 20 in the raised or lowered position, the hand truck 10 will be stably supported by the stabilizing legs 34 and the rear wheels 22. The hand truck 10 can then be moved forwards or backwards while remaining vertically oriented, so as to position the hand truck in a desired location relative to the truck from which the kegs are to be lowered. If a brake is provided, it can be set to prevent the hand truck 10 from rolling from the desired position. Once a keg is lowered on the platform 20 to the down position, the hand truck 10 can be operated in a conventional manner by tipping the top portion of the hand truck 10 rearward, and rolling the hand truck 10 on the rear wheels 22. When the hand truck 10 is tipped rearward, a keg placed on the platform will lean against the support bar 82. If desired, a keg or other load can be strapped to the support bar 82 to prevent the load from undesirably shifting on the platform.

In one embodiment of a method of use, the hand truck 10 can be positioned on the ground adjacent a truck loading surface, and oriented upright. The platform 20 can then be raised to the desired height by releasing the lock and the resistance device, and allowing the springs to pull the platform upwards. The hand truck 10 can then be moved forwards to a position in which the platform overlaps a portion of the truck loading surface. In one embodiment, the platform can be raised to a position substantially above a truck loading surface in order to receive a keg on an upper stack. Once the platform is in the desired position, a keg can be loaded onto the platform, and the platform can be lowered by selectively releasing the resistance device. In a situation where the platform overlaps the truck loading surface, the hand truck can be moved backwards while remaining in an upright position. Once the path between the platform and the ground is clear, the platform can be lowered completely to the ground, and the keg can be unloaded at ground level.

As will be clear to the skilled artisan in view of the present disclosure, the system components need not be oriented as shown in the illustrations. For example, the system could be configured such that the cylinder travels upwards as the platform travels upward. Alternatively still, the cylinder could be omitted entirely and replaced by another variable resistance device such as a brake or other friction-increasing device. The skilled artisan will also recognize that the mathematical relationships described above are idealized, and frictional forces between the various moving components will also be present.

Although certain embodiments and examples have been described herein, it will be understood by those skilled in the art that many aspects of the methods and devices shown and described in the present disclosure may be differently combined and/or modified to form still further embodiments. Additionally, it will be recognized that the methods described herein may be practiced using any device suitable for performing the recited steps, and the devices described herein can be used in other applications beyond those described. Such alternative embodiments and/or uses of the methods and devices described above and obvious modifications and equivalents thereof are intended to be within the scope of the present disclosure. Thus, it is intended that the scope of the present invention should not be limited by the particular embodiments described above, but should be determined only by a fair reading of the claims that follow.

1. A hand truck comprising:
a frame having a top portion, a bottom portion, and a longitudinal axis extending between the top portion and the bottom portion;
at least one handle mounted to the frame adjacent the upper portion;
a pair of wheels attached to the frame adjacent the bottom portion;
a platform having a substantially planar upper surface that is oriented substantially perpendicular to the longitudinal axis of the frame;
wherein the platform is configured to move axially along said longitudinal axis while maintaining said perpendicular orientation.

2. The hand truck of claim 1, wherein said platform is configured to lower a weight of between about 130 and about 170 pounds to a ground surface from a height of about 68″.

3. The hand truck of claim 1, wherein said platform is configured to lower a weight of about 160 pounds from a height of about 68″ at a controlled rate.

4. The hand truck of claim 1, wherein the platform comprises an upper surface with a width of about 19″ and a depth of about 19″.

5. The hand truck of claim 1, further comprising a pneumatic cylinder configured to control a rate of descent of said platform.

6. The hand truck of claim 1, further comprising at least one spring in mechanical communication with said platform, said spring biasing said platform toward a raised position.

7. The hand truck of claim 1, further comprising a brake configured to lock at least one of the wheels from rotation.

8. The hand truck of claim 1, wherein the platform is configured to support a beer keg.

9. The hand truck of claim 1, further comprising at least one stabilizing leg extending forward from the frame, said at least one stabilizing leg having a wheel attached thereto.

10. A device comprising:
a frame comprising at least one vertical frame member having a pair of wheels mounted to a bottom portion thereof;
at least one handle mounted to the frame and extending rearwardly;
at least one stabilizing leg mounted to the bottom portion of the at least one frame member and extending forwardly;
a planar platform movably attached to the frame and extending forwardly from the at least one frame member, the platform being configured to move vertically along the vertical frame member;
a resistance device coupled to the platform and configured to resist a gravitational force acting downwards on the platform.

11. The device of claim 10, wherein the resistance device comprises at least one spring.

12. The device of claim 10, wherein the resistance device comprises a pneumatic cylinder.

13. The device of claim 10, wherein the resistance device comprises a control configured to vary a resistance force of the resistance device.

14. The device of claim 10, wherein the platform is configured to lower a weight of between about 130 and about 170 pounds from a height of about 68″.

15. The device of claim 10, wherein the platform comprises an upper surface with a width of about 19″ and a depth of about 19″.

16. The device of claim 10, further comprising at least one spring in mechanical communication with said platform, said spring biasing said platform toward a raised position.

17. The device of claim 10, further comprising a brake configured to lock at least one of the wheels from rotation.

18. The device of claim 10, further comprising a brake configured to lock both of the wheels from rotation.

19. A method of lowering a weight from a height, the method comprising:
placing a weight on a raised platform which is vertically movable on a hand-truck frame, the hand truck frame also comprising at least one wheel mounted to a lower portion thereof;
opening a valve coupled to a pneumatic or hydraulic cylinder; and lowering the weight on the platform to a ground level;
closing the valve; and
removing the weight from the platform.

20. The method of claim 19, further comprising controlling a rate of descent of the weight by varying a flow rate through the valve.
